(19) United States
(12) Patent Application Publication
(10) Pub. No.: US 2019/0297847 A1
(43) Pub. Date: Oct. 3, 2019

(54) REMOTE-CONTROLLED PET CHASE TOY

(71) Applicant: JOYCE MAYER, FORT THOMAS, KY (US)

(72) Inventor: JOYCE MAYER, FORT THOMAS, KY (US)

(21) Appl. No.: 15/944,200

(22) Filed: Apr. 3, 2018

(51) Int. Cl. A01K 15/02; A63H 17/26

(52) U.S. Cl. CPC A01K 15/025; A63H 17/36; A01K 15/027; A63H 17/262

(57) ABSTRACT

The remote-controlled pet chase toy comprises a chassis and a body. One or more front wheels on the chassis are remotely steerable and one or more rear wheels may be driven by a drive motor on the chassis. The direction and velocity of the remotely-controlled pet chase toy may be controlled from a remote location via wireless signals sent from a remote control to a transceiver on the chassis. The wireless signals are passed from the transceiver to a control unit modifying the overall operation of the steering servo, drive motor, and a camera. The body may resemble an animal that would interest the pet. As non-limiting example, the body may resemble a squirrel, rabbit, or mouse. The camera may provide images of the area in front of the toy to the remote control to allow the remote driver to avoid obstacles.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of pet toys, more specifically, a remote-controlled pet chase toy.

### SUMMARY OF INVENTION

The remote-controlled pet chase toy comprises a chassis and a body. One or more front wheels on the chassis are remotely steerable and one or more rear wheels may be driven by a drive motor on the chassis. The direction and velocity of the remotely-controlled pet chase toy may be controlled from a remote location via wireless signals sent from a remote control to a transceiver on the chassis. The wireless signals are passed from the transceiver to a control unit, modifying the overall operation of the steering servo, drive motor, and a camera. The body may resemble an animal that would interest the pet. As non-limiting example, the body may resemble a squirrel, rabbit, or mouse. The camera may provide images of the area in front of the toy to the remote control to allow the remote driver to avoid obstacles.

An object of the invention is to provide a mobile toy for a pet to chase.

Another object of the invention is to control the direction and velocity of the mobile toy from a remote location.

A further object of the invention is to provide images from a camera showing the area in front of the pet toy on the remote control.

Yet another object of the invention is to provide control of the module toy using a software application running on a smart device.

These together with additional objects, features and advantages of the remote-controlled pet chase toy will be readily apparent to those of ordinary skill in the art upon reading the following detailed description of the presently preferred, but nonetheless illustrative, embodiments when taken in conjunction with the accompanying drawings.

In this respect, before explaining the current embodiments of the remote-controlled pet chase toy in detail, it is to be understood that the remote-controlled pet chase toy is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the remote-controlled pet chase toy.

It is therefore important that the claims be regarded as including such equivalent construction insofar as they do not depart from the spirit and scope of the remote-controlled pet chase toy. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a front view of an embodiment of the disclosure.

FIG. 2 is a side view of an embodiment of the disclosure.

FIG. 3 is a bottom view of an embodiment of the disclosure.

FIG. 4 is a detail view of an embodiment of the disclosure showing the top of the chassis.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

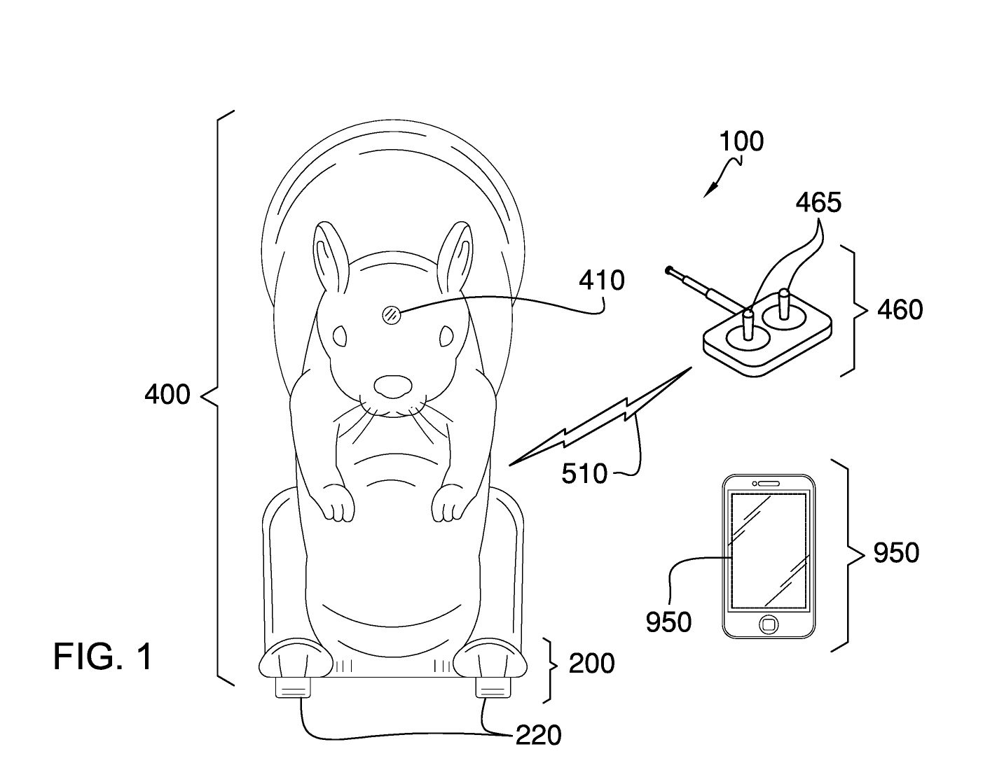

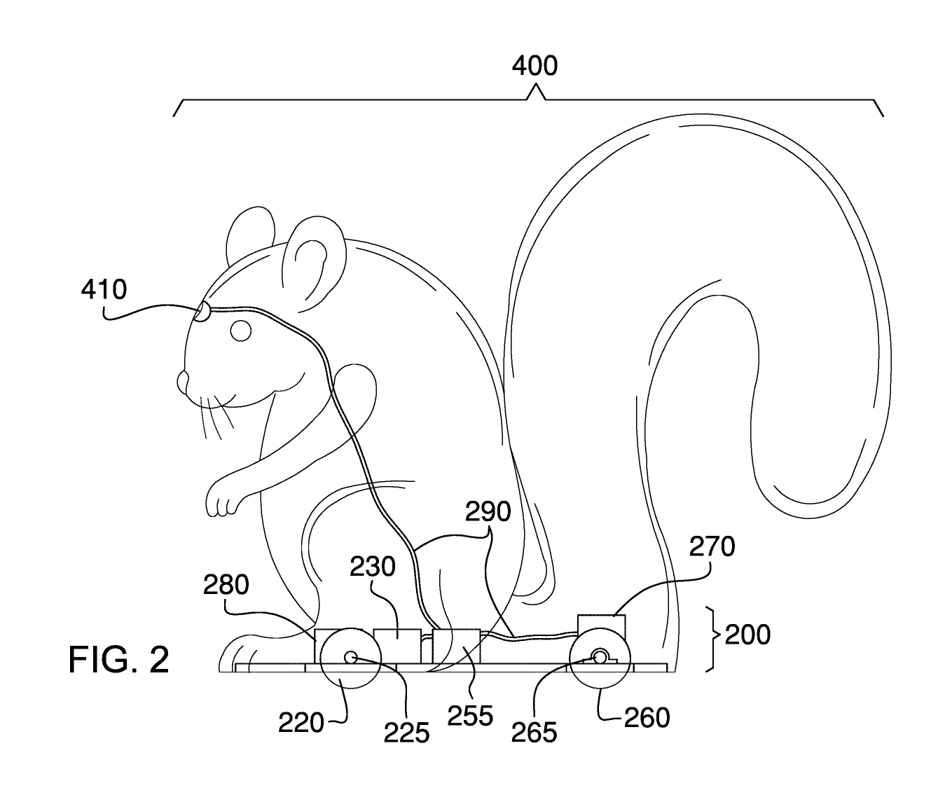

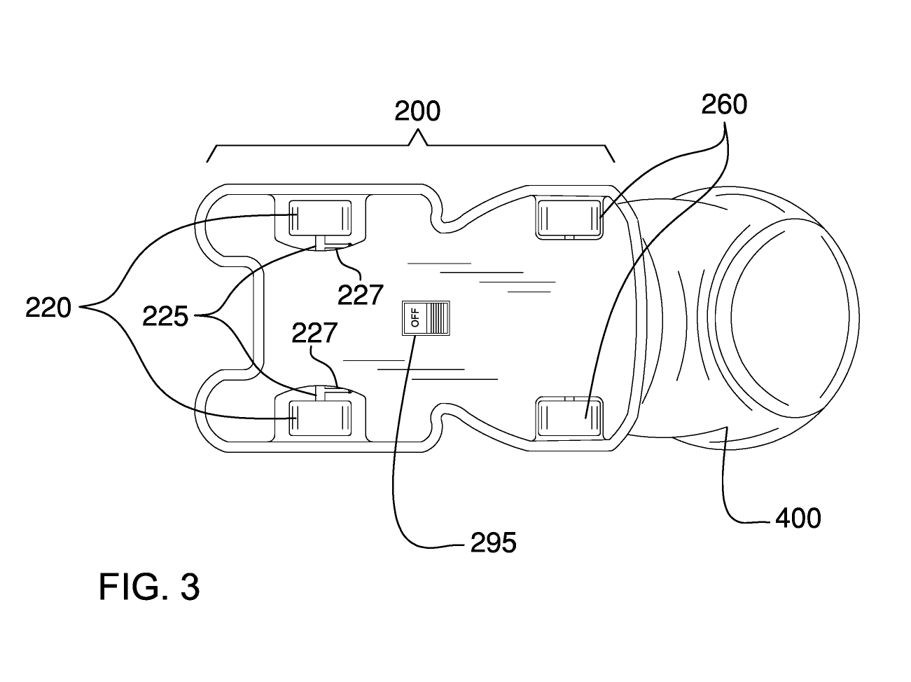

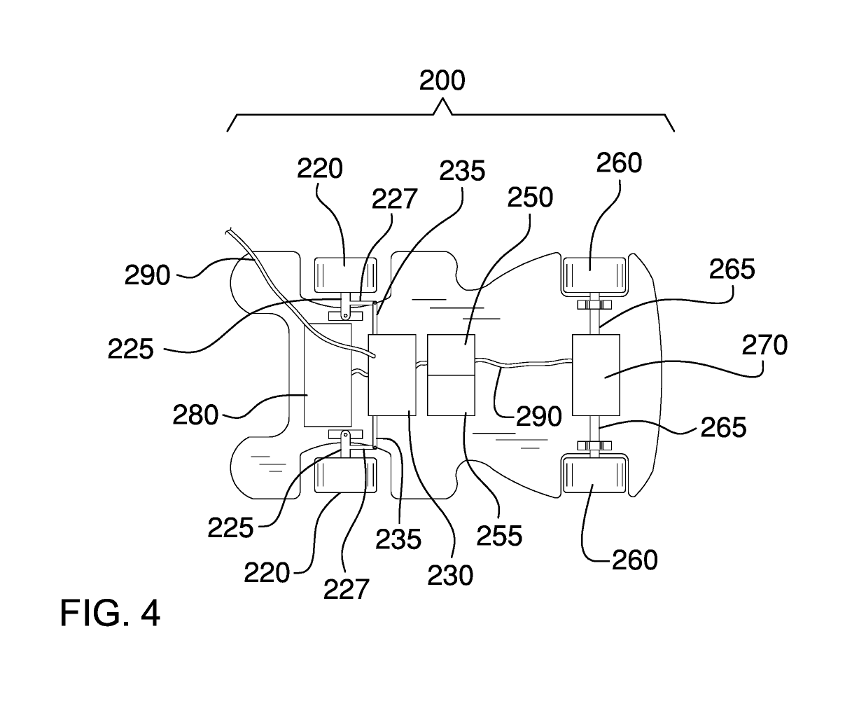

Detailed reference will now be made to a first potential embodiment of the disclosure, which is illustrated in FIGS. 1 through 4.

The remote-controlled pet chase toy 100 (hereinafter invention) comprises a chassis 200 and a body 400. The invention 100 may be a mobile toy adapted for use with a pet (not illustrated in the figures). The invention 100 may move under its own power. The invention 100 may be adapted to be steered by a user (not illustrated in the figures) from a remote location via a wireless connection using wireless signals 510.

The chassis 200 comprises one or more front wheels 220, a steering servo motor 230, one or more rear wheels 260, a drive motor 270, a controller 250, a battery 280, and a switch 295. The chassis 200 may couple to the body 400. Together, the shape of the chassis 200 and the body 400 may be adapted to resemble a figure that the pet may want to chase. As non-limiting examples, the chassis 200 and the body 400 may resemble a squirrel, a rabbit, a mouse, a bird, or another animal. The chassis 200 may therefore be shaped to match the footprint of the body 400.

Each individual front wheel may be coupled to a front axle 225. The front axle 225 may be pivotably coupled to the chassis 200. A steering arm 227 may couple the front axle 225 to a steering actuator 235. The coupling of the steering arm 227 to the steering actuator 235 may be pivotable. Lateral movement of the steering actuator 235 may turn the one or more front wheels 220 in unison such that the one or more front wheels 220 remain substantially parallel to each other and point in the same direction. The one or more front wheels 220 may be oriented to roll straight ahead when the steering servo motor 230 has centered the steering actuator 235.

The steering servo motor 230 may be a rotary actuator or a linear actuator that allows for control of the angular or linear position, velocity, and/or acceleration of the one or more front wheels 220. Movements of the steering servo motor 230 may be controlled by the controller 250 which may apply electrical energy to the steering servo motor 230 to control the position of the one or more front wheels 220, the velocity of the one or more front wheels 220, the acceleration of the one or more front wheels 220, or a combination thereof. The steering servo motor 230 may change the orientation of the one or more front wheels 220 and may thereby alter the direction of travel of the chassis 200 when the drive motor 270 is energized. A rear axle 265 may be coupled to the drive motor 270 such that when the drive motor 270 is energized the one or more rear wheels 260 rotate.

The one or more rear wheels 260 may be coupled to the rear axle 265. The rear axle 265 may pass laterally across the chassis 200. The one or more rear wheels 260 may be oriented to roll straight ahead or straight back when the drive motor 270 is energized.

In some embodiments, there may be two of the one or more front wheels 220 and two of the one or more rear wheels 260.

The drive motor 270 may convert electrical energy into mechanical energy. The drive motor 270 may cause rotation of the rear axle 265 when electrical energy is applied to the drive motor 270. The electrical energy applied to the drive motor 270 may be controlled by the controller 250. The drive motor 270 may coupled to the chassis 200.

The controller 250 may comprise a processor and a memory. The memory may contain instructions for causing the processor to control operation of the drive motor 270, the steering servo motor 230, and a camera 410. As non-limiting examples, in response to the wireless signals 510 received by a transceiver 255, the controller 250 may cause the drive motor 270 to start or stop rotating, may cause the steering servo motor 230 to change position, may cause the camera 410 to capture one or more images.

The controller 250 may comprise the transceiver 255. The transceiver 255 may receive the wireless signals 510 from a remote control. The wireless signals 510 from the remote control may determine when the invention 100 moves, whether it moves forward or backwards, whether it changes direction of travel, and the velocity of the invention 100.

In some embodiments, the transceiver 255 may transmit the wireless signals 510 to the remote control. The controller 250 and the transceiver 255 may be adapted to allow the user who is located remotely to see where the invention 100 is being steered. This is done by the controller 250 sending the one or more images to the remote control via the transceiver 255 for display on the remote control.

The battery 280 may comprise one or more energy-storage devices. The battery 280 may be a source of electrical energy to operate the controller 250, the steering servo motor 230, the drive motor 270, and the camera 410. The battery 280 may be replaceable or rechargeable.

The switch 295 may be an electrical component comprising one or more sets of electrical contacts. The switch 295 may start and stop the flow of electricity through an electric circuit touching or separating the electrical contacts, thus completing or interrupting an electric circuit. The switch 295 may be accessible from the bottom of the chassis 200. The switch 295 may be moved to an off position to prevent operation of the invention 100. The switch 295 may be moved to an on position to enable movement of the chassis 200 and operation of the camera 410.

The controller 250, the steering servo motor 230, the drive motor 270, the battery 280, the camera 410, and the switch 295 may be connected by wiring 290.

The body 400 may be a covering for the top of the chassis 200. The body 400 may be composed of a durable, resilient material. As non-limiting examples, the body 400 may be composed of natural rubber, plastic, synthetic rubber, neoprene, GR-S, silicone, nitrile, butyl compounds, polyacrylate, urethane elastomers, or combinations thereof.

The body 400 may comprise the camera 410. The camera 410 may be located in a forward position of the body 400 where it has a view of the area in front of the invention 100. The camera 410 may capture the one or more images. The camera 410 may transfer the one or more images to the controller 250. The controller 250 may transmit the one or more images arriving from the camera 410 to the remote control via the wireless connection using the wireless signals 510. In some embodiments, the camera 410 and the controller 250 may transmit at least 12 frames per second to the remote control and the remote control may display the one or more images from the camera 410 as motion video.

In some embodiments, the remote control may be a handheld R/C transceiver 460 that is dedicated to remote control of the invention 100. The handheld R/C transceiver 460 may comprise one or more joysticks 465 for controlling at least the speed and directions of the invention 100.

In some embodiments, the remote control may be a smart device 950 running an application program 470. As a non-limiting example, the smart device 950 may be a smartphone. In these embodiments, the transceiver 255 within the invention 100 may be a cell phone circuit. Specifically, the transceiver 255 may operate on the same frequencies, at the some power levels, and using the same protocols as cell phones. It may therefore be possible to establish the wireless connection between the smart device 950 and the transceiver 255 via a cell phone network. The smart device 950 may be located in a different building, city, state, or country from the invention 100 and may still operate the invention 100.

The application program 470 may provide on-screen controls to direct movements of the invention 100, may present the one or more images arriving from the controller 250, and may communicate with the transceiver 255 in the invention 100. The application program 470 may be adapted to send the wireless signals 510 to the transceiver 255 in the invention 100 to carry out the operation that was selected at the smart device 950. Responsive to the wireless signals 510 arriving from the invention 100, the application program 470 may update the display of the smart device 950 so that the one or more images arriving from the invention 100 and shown.

In use, the invention 100 may be turned on using the switch 295 and then placed on the floor. The remote control may be used to cause the invention 100 to move and to steer. The invention 100 may be driven to an area within sight of the pet and may be driven throughout an area so that the pet may give chase. If the user is not in the same room as the invention 100, the user may see where to steer the invention 100 by viewing the one or more images presented to the user on the remote control.

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” refers to top and “lower” refers to the bottom. As a non-limiting example, the upper end of a vertical shaft is the top end of the vertical shaft.

As used in this disclosure, an “application” or “app” is software that is specifically designed for use with a personal computing device.

As used in this disclosure, an “axle” is a cylindrical shaft that is inserted through the center of an object such that the center axis of the object and the center axis of the axle are aligned and the object can rotate using the axle as an axis of rotation.

Throughout this document the terms “battery”, “battery pack”, and “batteries” may be used interchangeably to refer to one or more wet or dry cells or batteries of cells in which chemical energy is converted into electricity and used as a source of DC power. References to recharging or replacing batteries may refer to recharging or replacing individual cells, individual batteries of cells, or a package of multiple battery cells as is appropriate for any given battery technology that may be used. The battery may require electrical contacts which may not be illustrated in the figures.

As used in this disclosure, a “camera” is a sensor that converts light into electric signals that encode and records the spatial orientation of the captured light in a manner that reproduces the images seen by a human eye.

As used herein, the words “control” or “controls” are intended to include any device which can cause the completion or interruption of an electrical circuit; non-limiting examples of controls include toggle switches, rocker switches, push button switches, rotary switches, electromechanical relays, solid state relays, touch sensitive interfaces and combinations thereof whether they are normally open, normally closed, momentary contact, latching contact, single pole, multi-pole, single throw, or multi-throw.

As used herein, the words “couple”, “couples”, “coupled” or “coupling”, refer to connecting, either directly or indirectly, and does not necessarily imply a mechanical connection.

As used in this disclosure, a “display” is a surface upon which is presented an image, potentially including, but not limited to, graphic images and text, that is interpretable by an individual viewing the image. When used as a verb, “display” is defined as presenting such an image.

As used herein, the word “durable” refers to a material's ability to withstand wear, pressure, impact, heat, cold, sun exposure, and other forms of potentially damaging conditions without suffering any significant deterioration of quality or value.

As used in this disclosure, a “footprint” is the surface area occupied by an object.

As used herein, “front” indicates the side of an object that is closest to a forward direction of travel under normal use of the object or the side or part of an object that normally presents itself to view or that is normally used first. “Rear” or “back’ refers to the side that is opposite the front.

As used in this disclosure, when referring to an item or device, “handheld” indicates that the size and weight of the item or device is appropriate for operation while a person holds the item or device with one or both hands.

As used in this disclosure, the word “lateral” refers to the sides of an object or movement towards a side. Lateral directions are generally perpendicular to longitudinal directions. “Laterally” refers to movement in a lateral direction.

As used herein, a “linear actuator” is a device that produces linear motion. The device may be electromechanical, hydraulic, or pneumatic in nature. Upon activation by an electrical potential or by a change in fluid or air pressure, the overall length of the device may change—either by lengthening or shortening. In use, a first component of the linear actuator, which may be referred to as a motor or body, is fixed mounted to a first object and a second component of the linear actuator, which may be referred to as an actuator arm or lead screw, is fixed mounted to a second object. Activation of the device may cause the second component to linearly move relative to the first component thus changing the distance between the first object and the second object.

As used in this disclosure, a “motor” refers to a device that transforms energy from an external power source into mechanical energy.

As used in this disclosure, “orientation” refers to the positioning and/or angular alignment of a first object relative to a second object or relative to a reference position or reference direction.

As used herein, the terms “processor”, “central processor”, “central processing unit”, “CPU”, or “microprocessor” refer to a digital device that carries out the instructions comprising a computer program by performing basic arithmetic, logical, control, and input/out operations. The term “microprocessor” may additionally imply a level of miniaturization and power reduction that makes the device suitable for portable or battery operated systems.

As used in this disclosure, “remote control” refers to the establishment of control of a device from a distance. Remote control is generally accomplished through the use of an electrical device that generates electrically based control signals that are transmitted via radio frequencies to the device.

As used in this disclosure, “resilient” or “semi-rigid” refer to an object or material which will deform when a force is applied to it and which will return to its original shape when the deforming force is removed.

As used in this disclosure, a “servo” refers to a device that incorporates a feedback mechanism or electrical circuit that allows for the angular or linear positioning of the device.

As used in this disclosure, a “servo motor” is an electrical motor that further incorporates a feedback circuit that allows for the angular positioning of the electric motor.

As used herein, “smart device” refers to a portable electrical device comprising at least a processor, display, input device, and network connection. The input device is generally a touch screen, keyboard, or voice recognition. The network connection is generally wireless. Non-liming examples of smart devices may include smartphones, tablets, personal digital assistants, laptop computers, and smartwatches.

As used herein, the word “substantially” indicates that two or more attributes are the same except for a margin of error related to variances in materials, manufacturing processes, craftsmanship, installation, environmental conditions, or other factors that may influence the attributes and that the differences introduced by these factors are tolerable.

As used in this disclosure, a “switch” is an electrical device that starts and stops the flow of electricity through an electric circuit by completing or interrupting an electric circuit. The act of completing or breaking the electrical circuit is called actuation. Completing or interrupting an electric circuit with a switch is often referred to as closing or opening a switch, respectively. Completing or interrupting an electric circuit is also often referred to as making or breaking the circuit, respectively.

As used in this disclosure, a “transceiver” is a device that is used to transmit and/or receive signals. The signals may be audible, optical, or RF in nature.

As used in this direction, the “velocity” is a scalar value or a vector that describes the rate of change of position of an object with respect to time (often called speed) and/or the direction of the change of position of the object.

As used in this disclosure, a “wheel” is a circular object that revolves around an axle or an axis and is fixed below an object to enable it to move easily over the ground.

Throughout this document references to “wire”, “wires”, “wired”, or “wiring” may describe and/or show a single conductor when, in fact, two conductors may be required to power or control a subsystem; a convention used herein is to not show the common return conductor to which all electrical subsystems are connected—this common return conductor is a continuous electrical path and does not pass through any type of switch or other electrical component other than the possibility of passing through one or more connectors.

As used in this disclosure, “wireless” is an adjective that is used to describe a communication channel that does not require the use of physical cabling.

With respect to the above description, it is to be realized that the optimum dimensional relationship for the various components of the invention described above and in FIGS. 1 through 4, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A remote-controlled pet chase toy comprising:
a chassis and a body;
wherein the remote-controlled pet chase toy is a mobile toy adapted for use with a pet;
wherein the remote-controlled pet chase toy moves under its own power;
wherein the remote-controlled pet chase toy is adapted to be steered by a user from a remote location via a wireless connection using wireless signals.

2. The remote-controlled pet chase toy according to claim 1
wherein the chassis comprises one or more front wheels, a steering servo motor, one or more rear wheels, a drive motor, a controller, a battery, and a switch;
wherein the chassis couples to the body;
wherein the shape of the chassis and the body are adapted to resemble a figure that the pet wants to chase;
wherein the chassis is shaped to match the footprint of the body.

3. The remote-controlled pet chase toy according to claim 2
wherein each individual front wheel is coupled to a front axle;
wherein the front axle is pivotably coupled to the chassis;
wherein a steering arm couples the front axle to a steering actuator;
wherein the coupling of the steering arm to the steering actuator is pivotable;
wherein lateral movement of the steering actuator turns the one or more front wheels in unison such that the one or more front wheels remain substantially parallel to each other and point in the same direction;
wherein the one or more front wheels are oriented to roll straight ahead when the steering servo motor has centered the steering actuator.

4. The remote-controlled pet chase toy according to claim 3
wherein the steering servo motor is a rotary actuator or a linear actuator that allows for control of the angular or linear position, velocity, and/or acceleration of the one or more front wheels;
wherein movements of the steering servo motor is controlled by the controller which applies electrical energy to the steering servo motor to control the position of the one or more front wheels, the velocity of the one or more front wheels, the acceleration of the one or more front wheels, or a combination thereof;
wherein the steering servo motor changes the orientation of the one or more front wheels and thereby alters the direction of travel of the chassis when the drive motor is energized;
wherein a rear axle is coupled to the drive motor such that when the drive motor is energized the one or more rear wheels rotate.

5. The remote-controlled pet chase toy according to claim 4
wherein the one or more rear wheels are coupled to the rear axle;
wherein the rear axle passes laterally across the chassis;
wherein the one or more rear wheels are oriented to roll straight ahead or straight back when the drive motor is energized.

6. The remote-controlled pet chase toy according to claim 5
wherein there are two of the one or more front wheels and two of the one or more rear wheels.

7. The remote-controlled pet chase toy according to claim 5
wherein the drive motor converts electrical energy into mechanical energy;
wherein the drive motor causes rotation of the rear axle when electrical energy is applied to the drive motor;
wherein the electrical energy applied to the drive motor is controlled by the controller;
wherein the drive motor coupled to the chassis.

8. The remote-controlled pet chase toy according to claim 7
wherein in response to the wireless signals received by a transceiver, the controller causes the drive motor to start or stop rotating, causes the steering servo motor to change position, causes a camera to capture one or more images.

9. The remote-controlled pet chase toy according to claim 8
wherein the controller comprises the transceiver;
wherein the transceiver receives the wireless signals from a remote control;
wherein the wireless signals from the remote control determine when the remote-controlled pet chase toy moves, whether it moves forward or backwards, whether it changes direction of travel, and the velocity of the remote-controlled pet chase toy.

10. The remote-controlled pet chase toy according to claim 9
wherein the transceiver transmits the wireless signals to the remote control;
wherein the controller and the transceiver are adapted to allow the user who is located remotely to see where the remote-controlled pet chase toy is being steered;
wherein the controller sends the one or more images to the remote control via the transceiver for display on the remote control.

11. The remote-controlled pet chase toy according to claim 10
wherein the battery comprises one or more energy-storage devices;
wherein the battery is a source of electrical energy to operate the controller, the steering servo motor, the drive motor, and the camera;
wherein the battery is replaceable or rechargeable.

12. The remote-controlled pet chase toy according to claim 11
wherein the switch is an electrical component comprising one or more sets of electrical contacts;
wherein the switch starts and stops the flow of electricity through an electric circuit touching or separating the electrical contacts, thus completing or interrupting an electric circuit;
wherein the switch is accessible from the bottom of the chassis;
wherein the switch is moved to an off position to prevent operation of the remote-controlled pet chase toy;
wherein the switch is moved to an on position to enable movement of the chassis and operation of the camera.

13. The remote-controlled pet chase toy according to claim 12
wherein the body is a covering for the top of the chassis;
wherein the body is composed of a durable, resilient material.

14. The remote-controlled pet chase toy according to claim 13
wherein the body comprises the camera;
wherein the camera is located in a forward position of the body where it has a view of the area in front of the remote-controlled pet chase toy;
wherein the camera captures the one or more images;
wherein the camera transfers the one or more images to the controller;
wherein the controller transmits the one or more images arriving from the camera to the remote control via the wireless connection using the wireless signals.

15. The remote-controlled pet chase toy according to claim 14
wherein the camera and the controller transmits at least 12 frames per second to the remote control and the remote control displays the one or more images from the camera as motion video.

16. The remote-controlled pet chase toy according to claim 15
wherein the remote control is a handheld R/C transceiver that is dedicated to remote control of the remote-controlled pet chase toy;
wherein the handheld R/C transceiver comprises one or more joysticks for controlling at least the speed and directions of the remote-controlled pet chase toy.

17. The remote-controlled pet chase toy according to claim 15
wherein the remote control is a smart device running an application program.

18. The remote-controlled pet chase toy according to claim 17
wherein the smart device is a smartphone.

19. The remote-controlled pet chase toy according to claim 18
wherein the transceiver within the remote-controlled pet chase toy is a cell phone circuit;
wherein the transceiver operates on the same frequencies, at the some power levels, and using the same protocols as cell phones;
wherein the wireless connection between the smart device and the transceiver is established via a cell phone network.

20. The remote-controlled pet chase toy according to claim 19
wherein the application program provides on-screen controls to direct movements of the remote-controlled pet chase toy, presents the one or more images arriving from the controller, and communicates with the transceiver in the remote-controlled pet chase toy;
wherein the application program is adapted to send the wireless signals to the transceiver in the remote-controlled pet chase toy to carry out the operation that was selected at the smart device;
wherein responsive to the wireless signals arriving from the remote-controlled pet chase toy, the application program updates the display of the smart device so that the one or more images arriving from the remote-controlled pet chase toy and shown.
